(19) United States
(12) Patent Application Publication
(10) Pub. No.: US 2018/0025552 A1
(43) Pub. Date: Jan. 25, 2018

(54) Systems and Methods for Parcel Dimension Measurement

(71) Applicant: Carlos E Cano, Austin, TX (US)

(72) Inventor: Carlos E Cano, Austin, TX (US)

(21) Appl. No.: 15/655,021

(22) Filed: Jul. 20, 2017

Related U.S. Application Data
(63) Continuation-in-part of application No. 62/365,128, filed on Jul. 21, 2016.

(51) Int. Cl. G07B 17/00; G06F 9/44; G06T 7/62

(52) U.S. Cl. CPC G07B 17/00661; G06T 7/62; G06F 9/44; G07B 2017/00685

(57) ABSTRACT

The physical dimensions of a parcel are determined by taking a photograph of the parcel with a smart phone camera. An object of known dimensions is included in the photographic image. An App installed on the smart phone calculates the parcel dimensions by reference to the object of know dimensions and displays the result.

### CROSS-REFERENCE TO RELATED APPLICATIONS

The present application is related to, is a continuation-in-part of, claims priority from and benefit of U.S. provisional patent application Ser. No. 62/365,128, filed Jul. 21, 2016, and entitled Systems and Methods for Measuring the Dimensions of an Object, by the same inventor, the disclosure of which is incorporated herein by reference.

### TECHNICAL FIELD

The present invention relates to package delivery and particularly to systems and methods for measuring the dimensions of a package.

### BACKGROUND

The dimensions of a package may be determined in a variety of ways. Tape measure, measuring stick, ruler, sized bins, laser measurement, and so forth. Each of such methods has disadvantages, not the least being that one must have a ruler, bin, or laser handy. In today's world, unlike the aforementioned measuring means, everyone has a smart phone camera handy. The present invention provides a method to measure the dimensions of a package by taking a photograph of the package with a smart phone camera.

### SUMMARY

The present invention employs a smart phone application (“App”) whereby a package is placed next to a common object of known measurements, such as a coin. A photograph of the package/object combination is taken with the smart phone camera. The App analyzes the photograph as input, calculates the dimensions of the package from the dimensions of the known object, and provides the package dimensions as output.

An exemplary embodiment of a method for measuring the dimensions of a parcel entails providing a parcel dimension measuring App that is operable on a smart phone, installing the parcel measurement App on a smart phone having a camera and an output display, placing a common object of known dimensions sufficiently near the parcel such that the parcel and the common object may be sighted in the view finder of the smart phone camera, taking a photographic image wherein the image includes both the parcel and the common object using the parcel measurement App to analyze the photographic image, to calculate the dimensions of the parcel based on the known dimensions of the common object, and to display the calculated dimensions on the output display of the smart phone.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 is a method steps flow chart of a first method of the present disclosure.

### DETAILED DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In the following discussion and in the claims, the terms “including” and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the following description and claims to refer to particular system components and method steps. As one skilled in the art will appreciate, different companies may refer to a component by different names. This document does not intend to distinguish between components that differ in name but not function.

The present invention facilitates the measurement of any object without the need of measuring devices by comparing it optically with common objects with standard or known physical dimensions.

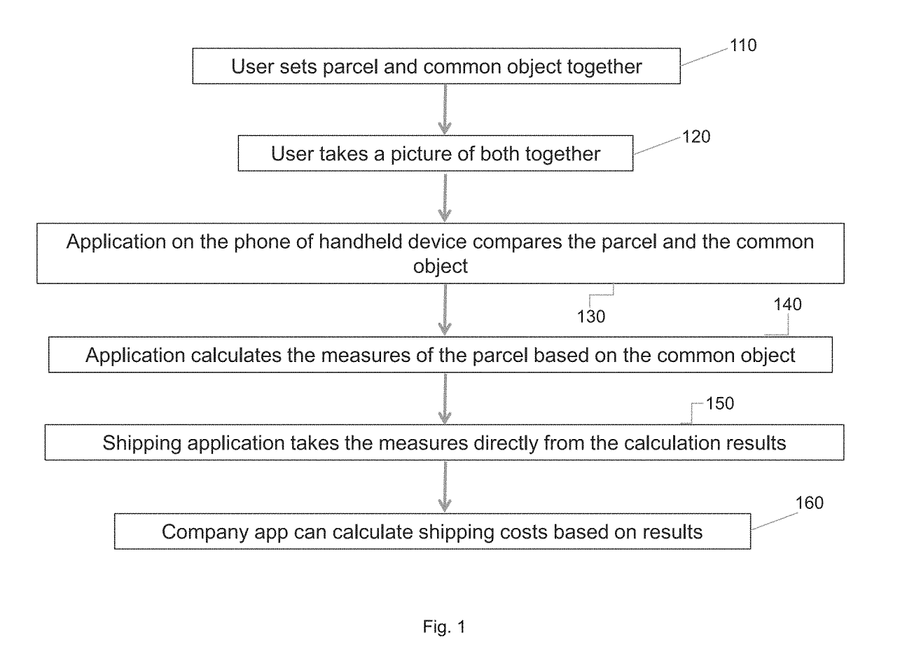

FIG. 1 is a method steps flow chart of a first method of the present disclosure. To determine the physical dimensions of a package, parcel, envelop, or any object, a user sets the parcel in close proximity to a common object of known dimensions 110. A parcel is defined as a package, letter, flat, container, or any object that has physical dimensions.

The user takes a photograph of the two objects together with a smart phone camera 120. A software application, commonly called an “App,” installed on the smart phone compares the parcel and the common object 130. The App calculates the dimensions of the parcel based on the known dimensions of the common object 140. Parcel shipping information is derived by the App from the calculated dimensions of the parcel 150. Shipping costs are calculated based on the derived shipping information 160.

Advantages of the methods of the present invention include the elimination of the need of measuring tapes or rulers; saves time to the shipper, increasing productivity; and elimination of the need to bring the parcel to a shipping location to have it measured. Additionally, the parcel dimension measuring method enables the shipper to request quotes immediately. Furthermore the method is adaptable to be used for measuring object dimensions in different industries and applications.

A system of the present invention to determine the dimensions of a parcel includes one or more smart phones, one or more Apps installed on the smart phones, at least one of the Apps being capable of calculating the dimensions of an object having unknown dimensions by reference to an object of known dimensions.

The present invention provides a method for measuring the dimensions of a parcel. The steps of the method include providing a parcel dimension measuring App that is operable on a smart device and installing the parcel measurement App on a device having a camera and an output display. A common object of known dimensions is placed sufficiently near the parcel such that the parcel and the common object are sighted in the view finder of the smart device camera. A digital image is recorded wherein the digital image includes both the parcel and the common object. The parcel measurement App is used to analyze the digital image, to calculate the dimensions of the parcel based on the known dimensions of the common object, and to display the calculated dimensions on the output display of the device.

The smart device of the method is a smart phone in specific exemplary embodiments. It will be understood by those skilled in the art that other smart devices are contemplated by this discloser, including for example, smart cameras, scanners, or any time of image capturing device capable of executing the functions of the present methods.

The common object used for comparison can be a coin, for example. It will be understood by those skilled in the art that the common object can be almost anything having standard dimensions and having a size such that it fits within the image captured by the smart device. Examples of such alternative common objects include credit cards, paper currency bills, business cards, gaming dice, playing cards, and so forth. Additionally, the dimensions of a common object can be entered by a user of the method into a database of common objects of known dimensions.

Alternative exemplary embodiments further provide the step of calculating a delivery price based on the calculated dimensions of the object. Other alternative embodiments of the method include the step of providing a database accessible by the App, where the database contains the dimensions of known objects by which to calculate the dimensions of the object of unknown dimensions.

The present invention also contemplates a system for measuring the dimensions of a parcel. Components of the system include, for example, one or more smart devices and one or more Apps installed on one or more of the one or more smart devices, at least one of the one or more Apps being capable of recognizing an object having known dimensions and calculating the dimensions of an object having unknown dimensions by reference to the object of known dimensions. Specific exemplary embodiments of the system include a database of dimensions of known objects, which database can be accessed by at least one of the one or more Apps installed on at least one of the one or more smart phones. Specific embodiments also include a network by which the one of more apps access the database.

In addition to the foregoing embodiments, the present disclosure provides programs stored on non-transient machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the Systems and Methods for Parcel Dimension Measurement functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Many modifications and other embodiments of the invention described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for measuring the dimensions of a parcel, the method comprising the steps of:
providing a parcel dimension measuring App that is operable on a smart device;
installing the parcel measurement App on a device having a camera and an output display;
placing a common object of known dimensions sufficiently near the parcel such that the parcel and the common object may be sighted in the view finder of the smart device camera;
recording a digital image wherein the digital image includes both the parcel and the common object;
using the parcel measurement App to analyze the digital image, to calculate the dimensions of the parcel based on the known dimensions of the common object, and to display the calculated dimensions on the output display of the device.

2. The method of claim 1, wherein the device comprises a smart phone.

3. The method of claim 1, wherein the common object comprises a coin.

4. The method of claim 1, wherein the common object is a credit card.

5. The method of claim 1 wherein the common object is a gaming die.

6. The method of claim 1, further comprising the step of calculating a delivery price based on the calculated dimensions of the object.

7. The method of claim 1, further comprising the step of providing a database accessible by the App, the database containing dimensions of known objects by which to calculate the dimensions of the object of unknown dimensions.

8. The method of claim 7, further comprising the step of entering the dimension of a common object into the database.

9. A system for measuring the dimensions of a parcel, the system comprising:
one or more smart devices;
one or more Apps installed on one or more of the one or more smart devices, at least one of the one or more Apps being capable of recognizing a object having known dimensions and calculating the dimensions of an object having unknown dimensions by reference to the object of known dimensions; and
a database of dimensions of known objects, which database can be accessed by at least one of the one or more Apps installed on at least one of the one or more smart devices.

10. The system of claim 9, wherein the smart device comprises a smart phone.

11. The system of claim 9, further comprising a network by which the one of more apps access the database.
